(19) United States
(12) Patent Application Publication
(10) Pub. No.: US 2010/0135101 A1
(43) Pub. Date: Jun. 3, 2010

(54) MINIMUM ADJUSTMENT CONCRETE DELIVERY SYSTEM

(76) Inventor: LARRY G. LEPPER, INDIANOLA, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/325,731

(22) Filed: Dec. 1, 2008

(51) Int. Cl. B28C 7/04; B28C 5/08; B28C 7/16; B28C 5/38

(52) U.S. Cl. 366/20; 141/100; 141/256; 141/284; 141/250

(57) ABSTRACT

A concrete delivery system includes a hopper having an open top and a discharge opening therein. A belt is trained around the front roller and the rear roller and the discharge opening is provided at the lower end of the hopper. A first positive displacement pump is connected to the liquid container and is driven by a rotatable shaft attached to one of the front or rear rollers for delivering the liquid from the liquid container to the mixer. A mixer is provided for mixing the material with the liquid and concrete mixture. The device includes a minimum of adjustment controls. An add mix fluid attachment may also be included in the addition to the liquid dispenser and this is controlled by the same shaft as the liquid dispenser is controlled.

### BACKGROUND OF THE INVENTION

The present invention relates to a minimum adjustment concrete delivery system.

Presently existing prior art relates to a mixture of variables, including the liquids being added, the add-mix being added, the aggregate being added, the cement being added, and various other adjustments. Because the training involves teaching these adjustable values, it is desirable to have a minimum adjustment delivery system which does not require the variable adjustments necessary on available prior art.

Therefore a primary object of the present invention is a minimum adjustment cement delivery system which minimizes the adjustments of liquid and concrete mixture for the mixer.

A further object is a minimum adjustment concrete delivery system which utilizes a descending baffle at the rear or discharge end of the hopper to produce a leveling and prevent flowby of the concrete mixture dumped on to a belt conveyor. This causes accurate metering of the concrete mixture.

A further object of the present invention is the provision of a minimum adjustment concrete delivery system which utilizes an L-shaped gate having an upstanding leg and having an approximate horizontal leg.

A further object of the present invention is the provision of a minimum adjustment concrete delivery system which has a horizontal leg that is at least one-half foot long.

A further object of the present invention is the provision of a minimum adjustment concrete delivery system which utilizes a positive displacement pump for the liquid so that the liquid delivered is always proportional to the cement mixture being delivered.

A further object of the present invention is the provision of a minimum adjustment concrete delivery system which utilizes a positive displacement pump for the liquid being delivered and fluid add mixture so that the liquid and the fluid add mixture is always proportional to the cement mixture being delivered.

A further object of the present invention is the provision of a minimum adjustment concrete delivery system which utilizes a shaft drive that is connected to both the cement mixture and the liquid so that the shaft delivers the liquid to the concrete mixer at the same rate that the dry concrete mixture is added.

A further object of the present invention is the provision of a minimum adjustment concrete delivery system which utilizes a shaft drive that is connected to both the concrete mixture and the liquid and also to the fluid add mixture so that the shaft delivers the liquid and the fluid add mixture to the concrete mixture at the same ratio.

A further object of the present invention is the provision of a minimum adjustment concrete delivery system which minimizes the adjustment to the mixer.

A further object of the present invention is the provision of a minimum adjustment concrete delivery system which is durable in use, reliable in results, and simple in construction.

### BRIEF SUMMARY OF THE INVENTION

The foregoing objects may be achieved by a concrete delivery system comprising a frame. A hopper is mounted on the frame and has an open top, a bottom wall having a discharge opening therein, a rear wall, a front wall, and opposite side walls. A concrete mixture of dry material comprising aggregate, cement and supplementary cementatious materials is within the container. A belt is trained around a front roller and a rear roller spaced apart from one another on the frame for receiving the concrete mixture from the discharge opening of the hopper. The belt includes a first end thereof positioned beyond the discharge opening of the hopper. A gate having a lower edge is mounted above the belt. The lower edge of the gate creates a level amount of the concrete mixture on the belt after the belt passes below the lower edge of the gate. An elongated concrete mixer is provided having an open inlet end therein and having an enclosed area. A liquid container is contained on the frame and contains a liquid therein. A rotatable shaft is connected to one of the pair of rollers. A first positive displacement pump is connected to the liquid container and driven by the rotatable shaft for delivering the liquid from the liquid container to the mixer. The first end of the belt is above the open end of the mixture and discharges the concrete mixture of dry material into the open end of the mixer. The concrete mixture and the liquid remain in a constant ratio regardless of the speed of the belt. An auger is within the mixer and is adapted to mix the concrete mixture and the liquid.

According to another feature of the present invention an L-shaped gate is provided having an upstanding gate leg and a lower gate leg extending parallel to the belt. The lower gate leg causes a level amount of the concrete mixture on the belt after the belt passes below the lower gate leg of the gate. This lower leg prevents “Flow By” and contributes to the accurate metering of the dry concrete mixture.

A further object of the present invention is a first positive displacement pump connected within the liquid container and driven by the rotatable shaft for delivering the liquid from the liquid container to the mixer. The concrete mixture and the liquid remain in a constant ratio regardless of the speed of the belt.

A further object of the present invention is a baffle extending downwardly and forwardly to maintain the levelness of the concrete mixture after the belt passes below the edge of the gate. This baffle also contributes to the prevention of “Flow By” and also contributes to an accurate metering.

A further object of the present invention is a device which is attractive in appearance, efficient in operation, and durable in use.

### BRIEF DESCRIPTION OF THE DRAWINGS

FIG. 1 is a side elevational view of the minimum adjustment concrete delivery system.

FIG. 2 is a sectional view showing the baffle, the gate, and the level of mixture on the end of the belt.

FIG. 3 is a perspective view of the end of the belt and the opening of the mixer.

FIG. 4 is a perspective view of the gate of the mixer.

FIG. 5 is a sectional view taken along line 5-5 of FIG. 2.

### DETAILED DESCRIPTION OF THE PREFERRED EMBODIMENT

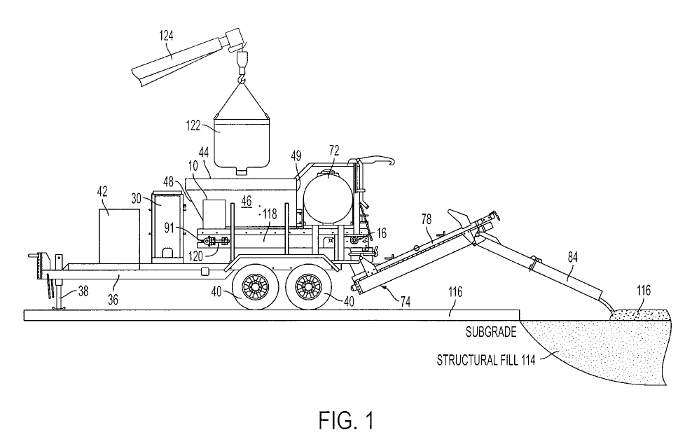

Referring to FIG. 1, a frame 36 includes a support 38 at its forward end and a pair of tandem wheels 40 at its rear end. A diesel 42 is mounted at the forward end of the frame and includes a mechanism (not shown) for driving the mixer of the present invention. The concrete delivery system can be a trailer mounted device or a self propelled unit.

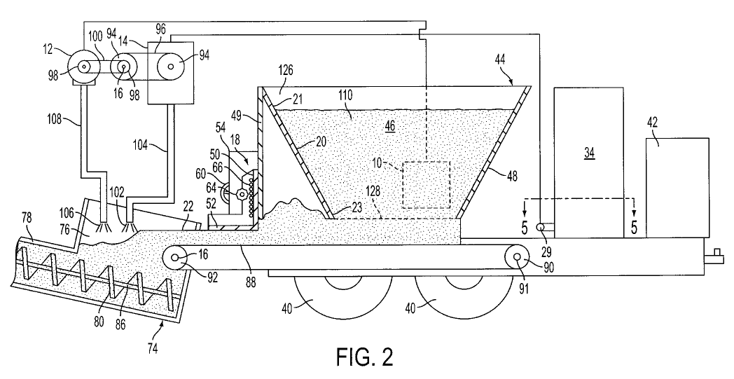

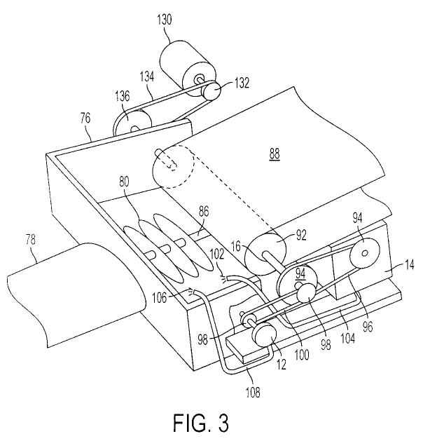

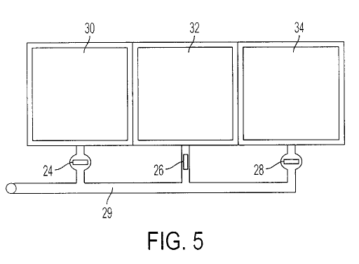

Referring to FIG. 5, a plurality of liquid containers 30, 32, and 34, include a first valve 24, a second valve 26, and a third valve 28. Valves 24, 26, 28 are shown with valves 24 and 28 in a closed position and valve 26 in an open position. The valves may be open or closed depending upon which of the liquids 30, 32, and 34 are necessary. Furthermore, combinations of valves 24, 26, 28 may be combined one with another to achieve the desired mix. Generally speaking, the liquids 30, 32, and 34 are related to liquids that enhance the curing of the concrete at different temperatures. The conduit 29 leads from the valves 24, 26, 28 to a liquid pump 14 (FIGS. 2 and 3).

A hopper 44 (FIGS. 1 and 2) includes opposite side walls 46 and a front wall 48 and a rear wall 49. A baffle 20 includes an upper end 21 and a lower end 23 which extends forwardly and downwardly from the rear end wall 49. This baffle 20 is important because it contributes to the concrete mixture 110 maintaining a level area 22 at its rearward end. It also contributes to the accurate metering of the concrete mixture 110 and prevents surging or “Flow By” when a bag is dumped into hopper 44.

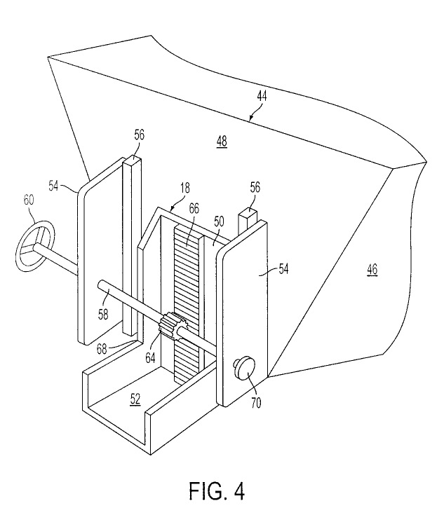

An L-shaped gate 18 is provided with an upstanding leg 50 and an approximate horizontal leg 52. The distance of horizontal leg 52 from upstanding leg 50 is at least one-half foot, and preferably at least a foot. This is important because the horizontal leg 52 also contributes to level the concrete material 22 shown at the rearward end of the hopper 44. With just an upstanding leg 50 the device will not work as well because the level 22 varies. A pair of flanges 54 and a pair of securing legs 56 provide a mounting place for a rod or shaft 58 (FIGS. 2 and 4). A wheel 60 includes a gear 64 fixed to the shaft 58 and intermeshing with a flat gear 66 on the upstanding leg 50. Gate side flanges 68 impart rigidity to the L-shaped gate 18. A stop flange 70 is provided on the end of shaft 58.

In operation, the baffle 20 and the horizontal portion 52 of L-shaped gate 18 contribute to the level area 22 of the concrete at the rear end of a belt 88 which is trained around a front roller 90 and a back roller 92. The rear roller 92 is mounted on the rear axle 16 and the front roller 90 is mounted on the front axle 91. A container for washout water 72 is mounted on the frame (FIG. 1) and is adapted to wash out a mixer 74. Mixer 74 includes a mixer inlet 76 and a mixer enclosed area 78. An auger having a flighting 80 thereon is mounted within the mixer and a motor (not shown) is fixed to a shaft 86 for rotating the shaft 86.

A conveyor motor 130 (FIG. 3) mounted on the operator's side power shaft 16 by means of sprockets 132, 136 having a roller chain 13 trained there around. Shaft 16 then powers pumps 12, 14 so that the liquid mix of 102 and the add mix fluid of 106 maintain a constant ratio from the rotation of the roller 92 and the shaft 16. Add mix fluid 106 may be eliminated in certain applications.

Also important is the baffle 20 which contributes together with the horizontal leg 52 to the irregular concret mixture being flattened from the irregular shape shown between baffle 20 and front wall 49 into the level area 22.

Referring again to FIG. 1, the fixed sides of the belt 118 includes a mechanical nut and bolt 120 which is attached to the front axle 91 so that adjustment may be provided.

A concrete dump 122 is provided at the end of a crane 124. Various devices may be utilized for the concrete dump, and bags can be utilized as well. The upper end of the hopper is open as designated by 126 (FIG. 2) and the bottom of the hopper 128 is shown to have a discharge opening therein. Vibrators, not shown, may be used to shake the concrete mixture downwardly.

The device uses a minimum of controls. Wheel 60 may be turned up or down to raise or reduce the level of the gate 18 so as to adjust the slump of the cement being mixed. Because the liquid mixture from cells 30, 32, 34 is entirely dependent upon the rotation of shaft 16, and because the level 22 is maintained, the concrete mixture has the same slump no matter what the rotation of shaft 16 is. Similarly, when the add fluid from box 10 is used, the same rotation of shaft 16 controls. The uses of positive displacement pumps 12, 14 is important too because of the fact that increase or decrease of shaft 16 cause output of pumps to increase or decrease respectively.

When it is desired to change the slump of the concrete having the liquid added all that is necessary is to turn wheel 60 (FIG. 2) in a clockwise or counterclockwise movement. Clockwise decreases the slump and counterclockwise increases the slump of the concrete.

In the drawings and specification there has been set forth a preferred embodiment of the invention, and although specific terms are employed, these are used in a generic and descriptive sense only and not for purposes of limitation. Changes in the form and the proportion of parts as well as in the substitution of equivalents are contemplated as circumstance may suggest or render expedient without departing from the spirit or scope of the invention as further defined in the following claims.

What is claimed is:

1. A concrete delivery system comprising:
a frame;
a hopper on the frame having an open top, a bottom wall having a discharge opening therein, a rear wall, a front wall, and opposite side walls;
a concrete mixture of dry material comprising aggregate and cement within the container;
a belt trained around a front roller and a rear roller spaced apart from one another on the frame for receiving the concrete mixture from the discharge opening of the hopper, the belt having first end thereof positioned beyond the discharge opening of the hopper;
a gate having a lower edge mounted above the belt, the lower edge of the gate creating a level amount of the concrete mixture on the belt after the belt passes below the lower edge of the gate to the portion positioned beyond the opening of the hopper;
an elongated mixer having an open inlet end therein and having an enclosed area;
a liquid container on the frame containing a liquid therein;
a rotatable shaft connected to one of the pair of rollers;
a first positive displacement pump connected to the liquid container and driven by the rotatable shaft for delivering the liquid from the liquid container to the mixer;
the first end of the belt being above the open end of the mixer and discharging the concrete mixture of dry material into the open end of the mixer, the concrete mixture and the liquid remaining in a constant ratio regardless of the speed of the belt; and
an auger within the mixer for mixing the concrete mixture and the liquid.

2. The concrete delivery system according to claim 1 wherein a second positive displacement pump is mechanically connected to the rotatable shaft and is fluidly connected to an admix container containing an admix fluid, the second positive displacement pump delivering the admix fluid to the mixer through the open end thereof.

3. The concrete delivery system according to claim 1 wherein the belt is spaced below the discharge opening of the hopper.

4. The concrete delivery system according to claim 1 wherein the rear wall of the hopper comprises a baffle extending downwardly and towards the front end of the belt.

5. The concrete delivery system according to claim 1 wherein the gate comprises an L-Shaped gate having an approximately vertical upper leg and a lower leg that is approximately horizontal.

6. The concrete delivery system according to claim 5 wherein the approximately horizontal leg extends at least one half foot.

7. A concrete delivery system comprising:
a frame;
a hopper on the frame having an open top, a bottom wall having a discharge opening therein, a rear wall, a front wall, and opposite side walls;
a concrete mixture of dry material comprising aggregate and cement within the container;
a belt moving below the discharge opening for receiving the concrete mixture from the hopper, the belt having a first end positioned beyond the discharge end of the hopper;
an L-shaped gate having an upstanding gate leg and a lower gate leg extending parallel to the belt, the gate causing a level amount of the concrete mixture on the belt after the belt passes below the lower gate leg of the gate;
an elongated mixer having an open end therein and having an enclosed area;
a liquid container on the frame containing a liquid therein;
a rotatable shaft having a pre- set rotational speed;
a first pump connected to the liquid container and driven by the rotatable shaft of pre-set rotational speed for delivering the liquid from the liquid container to the open end of the elongated mixer;
the first end of the belt discharging the concrete mixture of dry material into the mixer through the open end thereof; and
an auger within the mixer for mixing the cement mixture and the liquid.

8. The concrete delivery system of claim 7 wherein the first pump is a positive displacement pump.

9. The concrete delivery system of claim 8 wherein a second positive displacement pump is mechanically connected to the rotatable shaft and is fluidly connected to an admix container containing an admix fluid, the second positive displacement pump delivering the admix fluid to the mixer through the open end thereof.

10. The concrete delivery system of claim 7 wherein the belt is spaced below the discharge opening of the hopper.

11. The concrete delivery system of claim 7 wherein the front wall of the hopper comprises a baffle extending downwardly and towards the rear end of the belt.

12. A concrete delivery system comprising:
a frame;
a hopper on the frame and having an open top, a bottom wall having a discharge opening having a front edge and a rear edge, a rear wall, a front wall, and opposite side walls, a baffle in addition to the rear wall extending downwardly and rearwardly to engage the rear edge of the discharge opening;
a concrete mixture of dry material comprising aggregate and cement within the container;
a belt trained around a front roller and a rear roller spaced apart from one another on the frame for receiving the concrete mixture from the discharge opening of the hopper, the belt having first end thereof positioned beyond the discharge opening of the hopper;
a gate having a lower edge mounted above the belt, the lower edge of the gate creating a level amount of the concrete mixture on the belt after the belt passes below the lower edge of the gate;
an elongated mixer having an open end therein and having an enclosed area;
a liquid container on the frame containing a liquid therein;
a rotatable shaft connected to one of the front or rear rollers and having a fixed rotational speed;
a first positive displacement pump connected to the liquid container and driven by the rotatable shaft for delivering the liquid from the liquid container to the mixer;
the first end of the belt being above the open end of the mixer and discharging the concrete mixture of dry material into the open end of the mixer, the concrete mixture and the liquid remaining in a constant ratio regardless of the speed of the belt; and
an auger for mixing the concrete mixture and the liquid.
